(19) United States
(12) Patent Application Publication
(10) Pub. No.: US 2003/0085625 A1
(43) Pub. Date: May 8, 2003

(54) Monostable appliance timer

(76) Inventors: James Richard Windgassen, Clearwater, FL (US); Ryan Robert Munson, Tampa, FL (US)

Correspondence Address: JAMES WINDGASSEN AND RYAN MUNSON, 2866 CATHERINE DRIVE, CLEARWATER, FL, 33759, US

(21) Appl. No.: 09/682,982

(22) Filed: Nov. 5, 2001

(51) Int. Cl. H01H 43/00

(52) U.S. Cl. 307/139

(57) ABSTRACT

A timer whose purpose is to apply or remove power to or from an attached load during a monostable timing interval. A selection switch determines whether the attached appliance is on or off during the timing interval. The period of the timing interval is determined by the adjustment of a potentiometer or other control element and the timing interval is initiated by the closure of a momentary contact switch. Standard electrical interfaces are provided to allow the device to be interfaced to a standard receptacle and to provide a similar receptacle to the attached appliance.

### BACKGROUND OF INVENTION

Some small electrical appliances are now equipped with integral automatic shut off timers which automatically interrupt the power to the appliance after a predetermined time interval after activation. Appliances such as clothes irons, coffee pots, and cooking appliances employ these timing devices in order to reduce the risk of burn injuries and fires. These fires and injuries can occur when users forget to turn these appliances off.

U.S. Pat. No. 6,140,620 to Aldridge and Stewart describes a device for disconnecting electrical power from a heating element of an electric range after the device's timing interval has elapsed. The device utilizes a manually operated switch for determining the length of the timing interval. The power is applied to the heating element for a interval equal to the number of times the switch is closed multiplied by a predetermined time interval.

U.S. Pat. No. 4,494,012 to Coker describes a device that is designed to replace a standard wall mounted light switch which when activated applies power to a load for a predetermined interval of time. The device can also be used as a standard on-off switch. The Coker circuit employs a mechanical switch in series with the timing circuit and the load. When power is applied to the circuit it turns on for an interval of time and then turns itself off.

Commonly known mechanical countdown timers also exist that are used for controlling loads such as spas and saunas. These devices are used to turn on a load such as a jet pump in a spa for a period of time determined by the number of turns that a mechanical clock is wound. These devices do not provide the ability to turn a load on or off during a timing interval or a period of time. In addition, these devices are intended to be hard wired as a replacement for a conventional wall mount switch. Furthermore, these devices require a user to set the amount of time that they are on each time they are used; they do not retain a preset time delay.

The Aldridge and Stewart device is designed for the control of loads utilizing two active lines and a neutral line such as an electric stove and not a small appliance utilizing the more commonly used single active line and neutral. In addition, this design does not provide for selection of whether the attached load has power applied or removed during the timing interval. Furthermore, the Aldridge and Stewart device does not provide for continuous adjustment of the length of the timing interval; it requires the user to chose finite time steps.

The Coker device is designed as a wall switch replacement and thus does not provide a standard electrical receptacle to external devices. Also, this design does not have an integral enclosure for which the interface receptacle could be mounted. The Coker device also is designed to power itself off when its timing interval completes. This limits the methods by which the timing interval can be initiated. Power must be removed from the device and then reapplied to it before the timing interval can be restarted. This requires that the initiation switch must be able to carry the full load current of the device and the attached load. In addition, the Coker device does not provide for selection of whether the attached load has power applied or removed during the timing interval.

### SUMMARY OF INVENTION

The present invention, henceforth known as the timing device, is a device for OLE_LiNK2applying or removing power to or from an attached load during a timing intervalOLE_LINK2. The length of the timing interval is linearly adjustable between a minimum and a maximum allowable time setting by rotating a control knob. In addition, there is a switch which allows the user to select whether the power is applied or removed during the timing interval. The monostable or “one-shot” timing interval of the timing device is initiated by the user by actuating a control such as a momentary contact switch. The timing device is designed to plug into a standard electrical receptacle and provide a similar receptacle for the attached load. The power to the timing device's receptacle is applied or removed by the circuit or mechanism contained within the timing device.

The timing device is useful in any application where power needs to be applied or removed from an attached load during a timing interval of predetermined length. Loads that a user might want to apply power to for a predetermined amount of time and then automatically remove power from are soldering irons, coffee pots and other small electrical appliances with heating elements which can be hazardous if left on unintentionally. Loads such as these frequently cause fires and burns when unintentionally left on. Use of this novel device will also result in energy savings and conservation of natural resources. The energy savings is accomplished by using the timing device to remove power from loads such as lights and irrigation pumps after a predetermined time interval. A novel use of this timing device is when it is configured to remove power during its timing interval and then reapply it after the timing interval has completed. An example of this mode of usage is removing power from an aquarium water filtration system pump during the feeding of the fish so that the fish food is not ingested by the filtration system. The timing device then reapplies the power automatically after the feeding period has ended. The use of the timing device for this application prevents the user from forgetting to turn on the filtration pump after feeding the fish that can result in stress to, or death of the fish.

### BRIEF DESCRIPTION OF DRAWINGS

FIG. 1 depicts front, side and bottom views of the preferred embodiment;

FIG. 2 depicts a schematic of a possible embodiment of the timing device;

FIG. 3 depicts a schematic of the preferred embodiment of the timing device;

### DETAILED DESCRIPTION

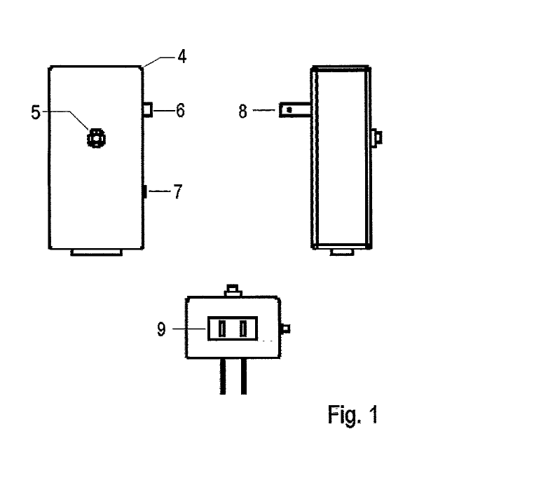

FIG. 1 depicts front, side and bottom views of one preferred embodiment of the present invention. Enclosure (4) of this prototype of the present invention is a small commercially available plastic enclosure with a built in electrical interface (8). A timing interval initiation switch (5) is easily accessible to the user and is located on the front cover. However, a remote activation port which enables remote activation can also be easily added. The on/off during timing interval select switch (6) is on the side of the enclosure. The time duration set potentiometer (7) is also located on the side of the enclosure. Finally, the controlled standard electrical receptacle (9) is located on the bottom to provide for ease of use.

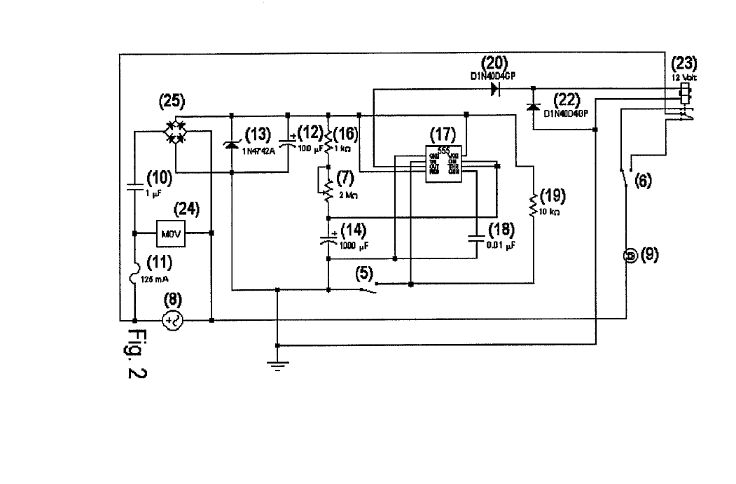

FIG. 2 depicts one of several methodologies for the implementation of the present invention. As shown, the input to the circuit is 120V, 60 Hz AC which is fed into the circuit by a standard electrical interface (8). MOV (24) protects the circuit from destructive voltage spikes on the AC line while fuse (11) protects the circuit from overcurrent conditions caused by a circuit failure. Capacitor (10) provides an impedance to limit the AC current flowing through full wave bridge rectifier (25) which rectifies the incoming AC to pulsating DC. This is followed by zener diode (13) which functions as a shunt regulator to limit the voltage on smoothing capacitor (12) to 12 volts DC. The 12 volts DC is fed to a 555 IC timing circuit configured as a monostable circuit. The time interval of the timing interval is determined by resistor (16), user adjustable potentiometer (7), and capacitor (14). Resistor (16) determines the minimum allowable timing interval and potentiometer (7) determines the timing interval between the minimum and the maximum setting. A timing interval is initiated by the user closing normally open momentary contact switch (5). During the timing interval, the output pin of the 555 IC (17) goes high and energizes the coil of the SPDT relay (23). Diodes (20) and (22) provide protection from the inductive flyback voltage developed across the coil of SPDT relay (23) at the end of the timing interval when the output of the 555 IC (17) goes low and the coil of SPDT relay (23) is de-energized. User operated SPDT switch (6) controls whether the standard alternating current electrical receptacle (9) is energized or de-energized during the timing interval.

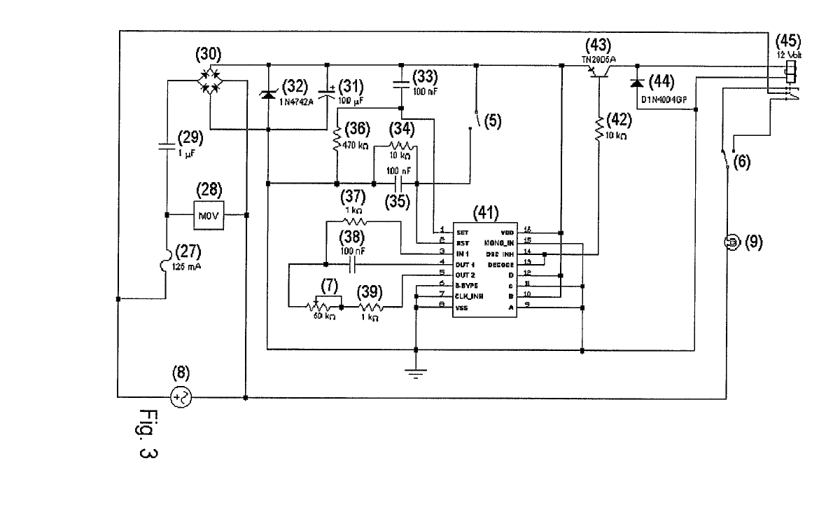

FIG. 3 depicts one preferred methodology for the implementation of the present invention. As shown, the input to the circuit is 120V, 60 Hz AC which is fed into the circuit by a standard electrical interface (8). MOV (28) protects the circuit from destructive voltage spikes on the AC line while fuse (27) protects the circuit from overcurrent conditions caused by a circuit failure. Capacitor (29) provides an impedance to limit the AC current flowing through full wave bridge rectifier (30) which rectifies the incoming AC to pulsating DC that is followed by zener diode (32) which functions as a shunt regulator to limit the voltage on smoothing capacitor (31) to 12 volts DC. The 12 volts DC is fed to a MC 14536B programmable 24 stage binary ripple counter IC (41) timing circuit configured as a monostable timing circuit. The frequency of the clock oscillator contained within the MC 14536B IC (41) is determined by resistors (37, 39), user adjustable potentiometer (7), and capacitor (38). The output of the clock oscillator is fed into a 24 stage ripple counter contained within the MC 14536B IC (41). The circuit as shown is configured such that the output of the ripple counter is taken from the 18^{th} stage which represents 2¹⁷+1 clock cycles. The decode pin of counter IC (41) goes high and ends the timing interval. Resistor (36) is connected between the set pin of the counter IC (41) and DC ground; this is a pull down resistor which normally keeps the set pin of the counter IC (41) low. Capacitor (33) is connected between 12V DC and the set pin of OLE_LINK1 the counter IC (41 OLE_LINK1). Capacitor (33) pulls the set pin of counter IC (41) to a high state when the circuit is initially powered to prevent a timing interval from being initiated when AC power is first applied. Resistor (34) is connected between DC ground and the reset pin of the counter IC (41) which keeps this pin normally pulled low until a timing interval is initiated by pulling this pin high. The reset pin of the counter IC (41) is pulled high by the user closing normally open momentary contact switch (5). Capacitor (35) is connected between the reset pin on the counter IC (41) and DC ground to prevent spurious triggering due to electrical noise coming from the AC line. The decode pin of the counter IC (41) is connected directly to the oscillator inhibit pin of counter IC (41) to stop the oscillator when the decode pin is set high. Also, the decode pin of IC (41) is connected to the base of a PNP transistor (43) via base resistor (42). When the decode pin of IC (41) goes low at the beginning of the timing interval, the PNP transistor (43) is activated and the coil of SPDT relay (45) is energized. Diode (44) shunts the flyback voltage developed across the coil of relay (45) when it is de-energized to prevent damage to other components from the high voltage that would otherwise be developed across the relay coil. User operated SPDT switch (6) controls whether the standard alternating current electrical receptacle (9) is energized or de-energized during the timing interval.

Many embodiments and variations of the present invention for applying or removing power to or from an attached load during a monostable timing interval are possible. However, it should be apparent that the disclosure of the previous two embodiments of the present invention will suggest many alternative designs to those skilled in the art.

1. A timing device comprising:
a) a monostable timing circuit or mechanism for applying or removing electrical power to or from an attached electrical load external to said device during a timing interval, and
b) an enclosure containing (a); and
c) electrical interfaces to allow said device to mate with an alternating current electrical receptacle, and
d) one or more alternating current electrical receptacles connected to (a), and
e) a means or multiple means for a user to initiate said timing interval, and
f) a means for setting the length of the timing interval which when set will retain the time setting on a activation to activation basis and when the timing device is unpowered.
